(19) United States
(12) Patent Application Publication
(10) Pub. No.: US 2007/0013201 A1
(43) Pub. Date: Jan. 18, 2007

(54) Cargo space partition

(76) Inventors: Josef Wagner, Munchen (DE); Roland Kuhn, Grafing (DE)

Correspondence Address: HONIGMAN MILLER SCHWARTZ & COHN LLP, 38500 WOODWARD AVENUE, SUITE 100, BLOOMFIELD HILLS, MI, 48304-5048, US

(21) Appl. No.: 11/195,215

(22) Filed: Aug. 2, 2005

(30) Foreign Application Priority Data
Aug. 3, 2004 (DE) 10 2004 037 800.2

(51) Int. Cl. B60R 21/06

(52) U.S. Cl. 296/24.43

(57) ABSTRACT

The invention proposes a cargo space partition with a first and a second plate-shaped element, wherein the first plate-shaped element is arranged on the back rest of a rear seat or a rear bench seat such that it can be pivoted about an essentially horizontal axis, and wherein the plate-shaped elements are connected to one another such that they can be interlocked and/or moved relative to one another to a limited degree. The invention also proposes a cargo space partition, in which one of the plate-shaped elements is arranged such that it can be displaced essentially perpendicular and in the horizontal direction along a section of the cargo space. In another embodiment, first and second separating members are hingedly connected and includes a locking member that engages a catch member to place the partition in a plurality of different configurations.

### BACKGROUND OF THE INVENTION

The present invention pertains to a cargo space partition for the cargo space of a motor vehicle, particularly a station wagon.

According to EP 1 283 130 A2, several covers in the form of cargo space partitions are provided behind the rear seat or the rear bench seat of a station wagon. These covers prevent luggage from being thrown from the cargo space into the passenger compartment in case of an emergency braking maneuver or a collision. According to the state of the art, several covers are required in order to take into account the entire range of functions covered by a station wagon. If the cargo space only contains little cargo, if any, it suffices to provide a horizontal cover that lies at the height of the upper edge of the back rest of the rear seat or the rear bench seat. This type of cover does not impair the view of the driver through the rear window. If the cargo space above the upper edge of the back rest of the rear seat or the rear bench seat is also utilized, it is practical to provide a vertical cover a short distance behind the back rest of the rear seat or rear bench seat, wherein this cover extends over the entire width of the motor vehicle and upward to the roof lining. This partition is realized in the form of a net or a comparably transparent interlaced fabric. Depending on the respective application, the unused cover of the cargo space partition can be stored in the rolled-up state.

These and comparable partitions for the cargo space of a station wagon have the disadvantage that the partition of a cargo space that was enlarged by folding over the back rest of the rear seat or the rear bench seat can only be realized, if at all, after carrying out complicated alterations.

### BRIEF SUMMARY OF THE INVENTION

The present invention is based on the objective of developing a cargo space partition that can be very easily adapted to the different configurations of a station wagon.

Each cargo space partition according to the invention has a high mechanical stability that cannot be easily achieved with conventional nets or the like. In addition, the cargo space partition according to the invention can be arranged in different positions and consequently adapted to the different configurations of a station wagon.

The cargo space partition according to the invention can be stored in a very small space when it is not in use.

### BRIEF DESCRIPTION OF THE DRAWINGS

Preferred embodiments of the present invention are described below with reference to the enclosed figures. The figures show:

FIG. 1 shows a cross-sectional side elevational view through a station wagon of a cargo space partition according to a first embodiment of the invention arranged in one possible position.

FIG. 2 shows a cross-sectional side elevational view of the cargo space partition of FIG. 1 arranged in a different position.

FIG. 3 shows a cross-sectional side elevational view of the cargo space partition of FIG. 1 arranged in yet a different position.

FIG. 4 shows a cross-sectional side elevational view of the cargo space partition of FIG. 1 arranged in yet another position.

FIG. 5 shows a cross-sectional side elevational view through a station wagon of a cargo space partition according to a second embodiment of the invention arranged in one possible position.

FIG. 6 shows a cross-sectional side elevational view of the cargo space partition of FIG. 5 arranged in a different position.

### DETAILED DESCRIPTION OF THE INVENTION

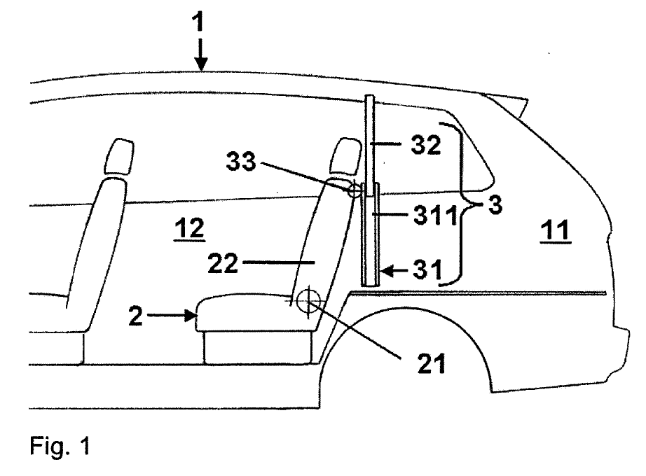

Referring now to FIGS. 1-4, the rear region of a station wagon 1 contains a cargo space 11 for transporting cargo. The area 12 situated in front of the cargo space 11 is either provided for accommodating passengers or cargo. The area 12 contains rear seat or a rear bench seat 2 that form(s) part of the motor vehicle equipment. The rear seat or the rear bench seat contains(s) a back rest 22 that can be pivoted about the axis 21.

According to the invention, the motor vehicle equipment also includes a first embodiment of a cargo space partition 3 with a first 31 and a second 32 plate-shaped element. The first plate-shaped element 31 is held on an upper section of the back rest 22 such that it can be pivoted about a horizontal axis 33. Means are provided for holding the plate-shaped elements 31, 32 such that they can be moved relative to one another, particularly in a mutually displaceable fashion. This can be advantageously achieved by providing the first plate-shaped element 31 with a pocket 311 for displaceably accommodating the second plate-shaped element 32. The second plate-shaped element 32 sectionally slides in guides arranged in the interior of the pocket 311 in this embodiment. In this respect, it is also practical to restrict the relative moveability between the plate-shaped elements 31, 32 with the aid of limit stops or the like such that the second plate-shaped element 32 is prevented from falling out of the pocket 311. If it should be possible to optionally remove the second plate-shaped element 32 from the pocket 311, the limit stops may be realized such that they can be detached by the user. The relative moveability is chosen such that the second plate-shaped element 32 substantially protrudes over the first plate-shaped element 31 on each of the longitudinal edges that lie transverse to the displacement path in one of its respective positions. In the embodiment shown, this is achieved in a particularly simple fashion by designing the pocket 311 such that it extends through the first plate-shaped element 31 and emerges on its two opposite edges.

According to FIG. 1, the first plate-shaped element 31 of the cargo space partition 3 is pivoted downward into an approximately vertical position behind the back rest 22 when the entire cargo space 11 is used. The second plate-shaped element 32 protrudes from the pocket on the upper edge of the first plate-shaped element 31 to such a degree that the opening between the cargo space 11 and the area 12 is at least largely closed. Due to these measures, no objects accommodated in the cargo space 11 can be thrown into the passenger compartment in case the motor vehicle collides with an obstacle, namely even if the cargo space is extensively utilized.

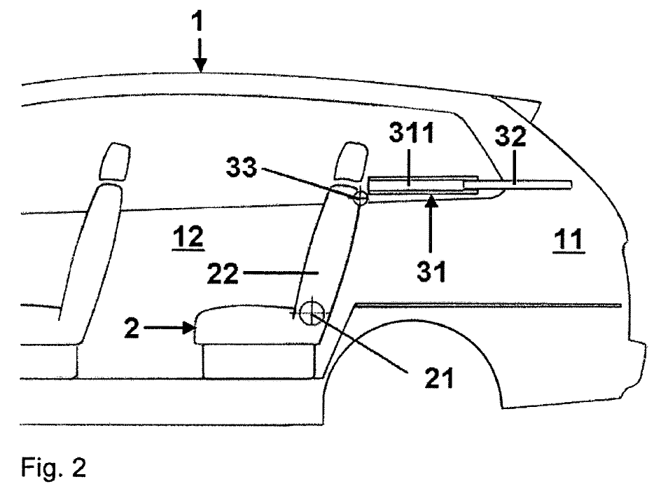

When the cargo space 11 is used less extensively as shown in FIG. 2, i.e., when only the section that approximately lies below the upper edge of the back rest 22 is used, the first plate-shaped element 31 is pivoted into an essentially horizontal position. The second plate-shaped element 32 is pulled out of the pocket 311 beyond its opening that faces away from the rear back rest and covers a section of the used cargo space 11 that lies in the region of the tailgate. In this configuration of the first embodiment of the cargo space partition 3, the view of the driver through the rear window is not impaired by the upwardly protruding second plate-shaped element 32.

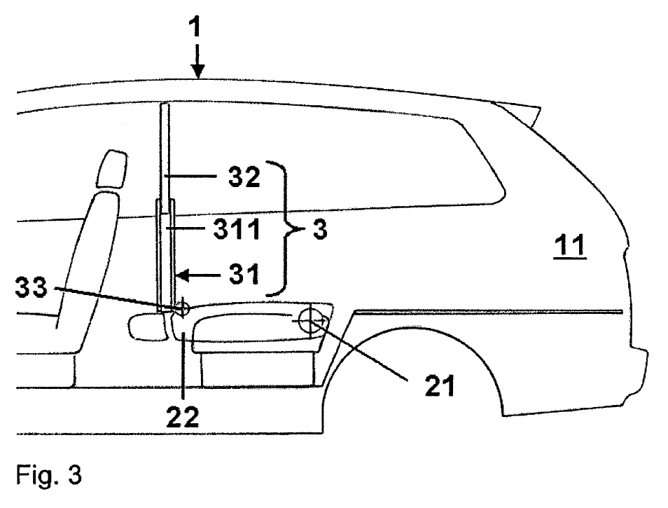

However, if the entire cargo space 11 as well as the area 12 is used for storing cargo as shown in FIG. 3, the back rest 22 of the rear seat or the rear bench seat 2 is folded forward such that it lies on the seat. The rear side of the back rest 22 is preferably arranged adjacent to the floor of the cargo space 11 such that it lies in the same plane. This simplifies the loading of the station wagon. The cargo space partition 3 essentially extends vertically upward relative to the back rest 22 in this case. The second plate-shaped element 32 is essentially arranged relative to the first plate-shaped element 31 in the same position as described above with reference to the configuration of the cargo space partition 3 shown in FIG. 2. In case of a head-on collision or an emergency braking maneuver, this configuration of the cargo space partition 3 prevents the cargo from being thrown into the passenger compartment.

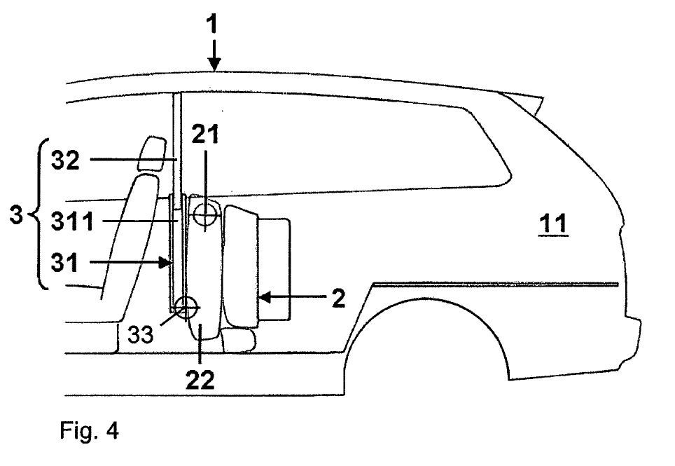

In the configuration of the station wagon shown in FIG. 4, the rear seat or the rear bench seat 2 is collapsed and folded forward in order to utilize the cargo space 11 and the area 12. The seat and the back rest 22 adjoin one another and are essentially positioned vertically. In this case, the cargo space partition 3 is arranged relative to the station wagon similar to the configuration described above with reference to FIG. 3. Both plate-shaped elements 31, 32 essentially protrude upward from the horizontal pivoting axis 33 in the region of the back rest 22. The second plate-shaped element 32 is displaced relative to the first plate-shaped element 31 to such a degree that the opening between the area 12 and the passenger compartment is largely closed.

Each of the plate-shaped elements 31, 32 may be manufactured, for example, of a rigid plate of plastic, wood or metal. In order to impair the view of the driver through the rear window as little as possible, at least the second plate-shaped element 32 may be provided with a window or the like. The window may be closed with a pane of transparent plastic, safety glass or a net in order to prevent the cargo from being thrown through the window opening. In one particularly simple and light-weight embodiment, each of the plate-shaped elements 31, 32 is realized in the form of a stable frame with a net or a similar transparent interlaced fabric fixed therein.

In another embodiment, one of the plate-shaped elements 31, 32 is provided with an opening that can be closed and serves for accommodating long objects, particularly skis and ski poles. With respect to the configuration shown in FIGS. 2 and 3, it is particularly practical to provide the first plate-shaped element 31 with such an opening.

When the cargo space partition 3 is used in motor vehicles with a divided rear bench seat or with several back seats 2, the cargo space 3 may also be vertically divided in the longitudinal direction of the motor vehicle. Alternatively, the cargo space partition 3 may also be arranged in a pivoted fashion on only part of the back rest 21 [sic; 22] of the rear bench seat 2 or on only one of several back rests. This would make it possible to fold the other part of the back rest 22 or the other back rests forward while the cargo space partition 3 can optionally remain in one of the configurations shown in FIGS. 1 and 2.

In an alternative variation of the first embodiment of the cargo space partition 3, the movable connection between the two plate-shaped elements 31, 32 is realized in the form of a pivoted connection. In this case, it would be possible to provide a hinge that has a limited pivoting angle, e.g., a semicircle, and can be locked in both end positions.

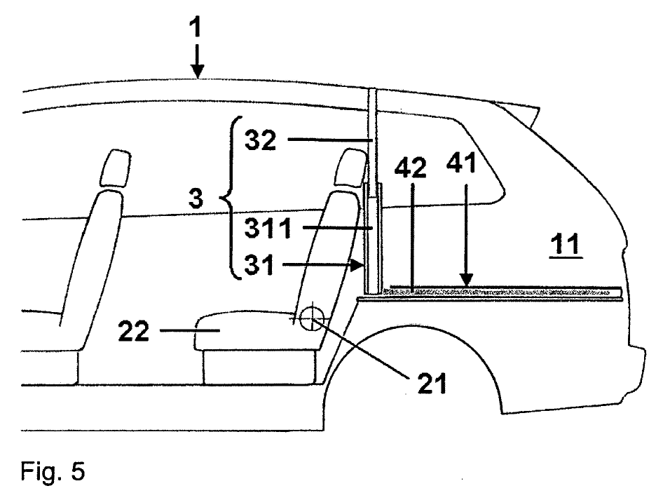

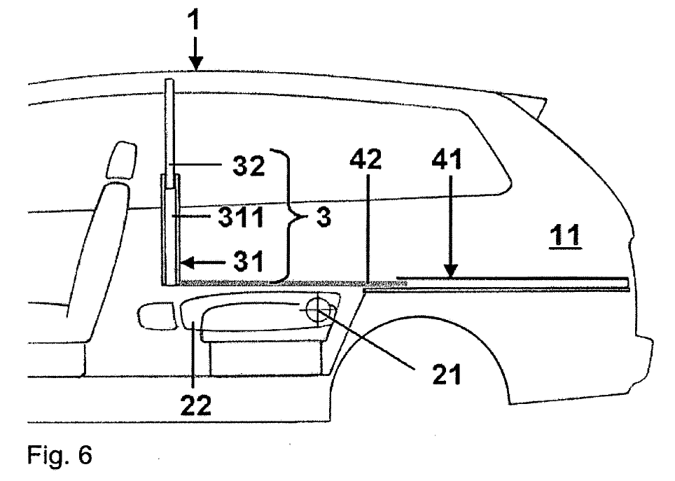

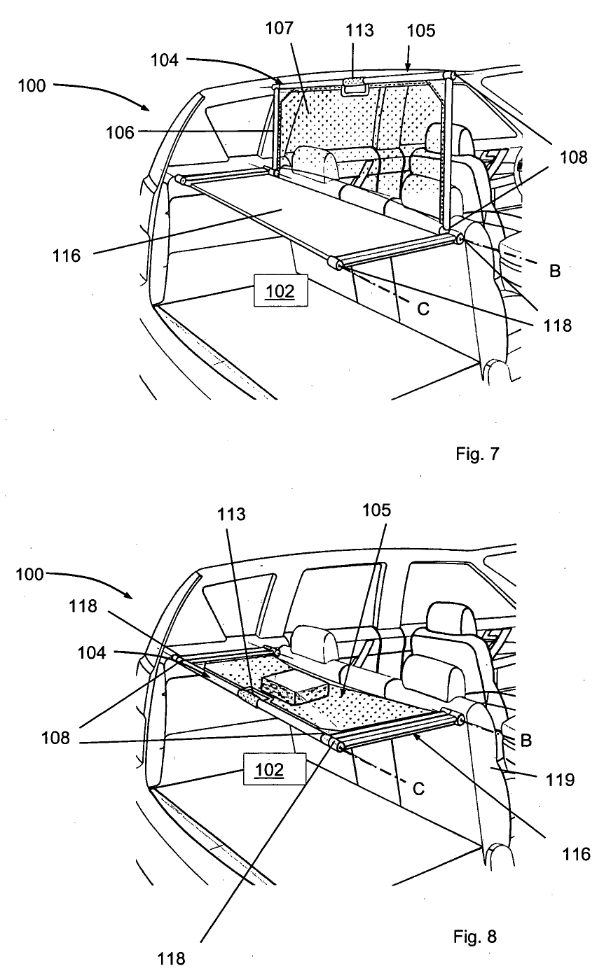

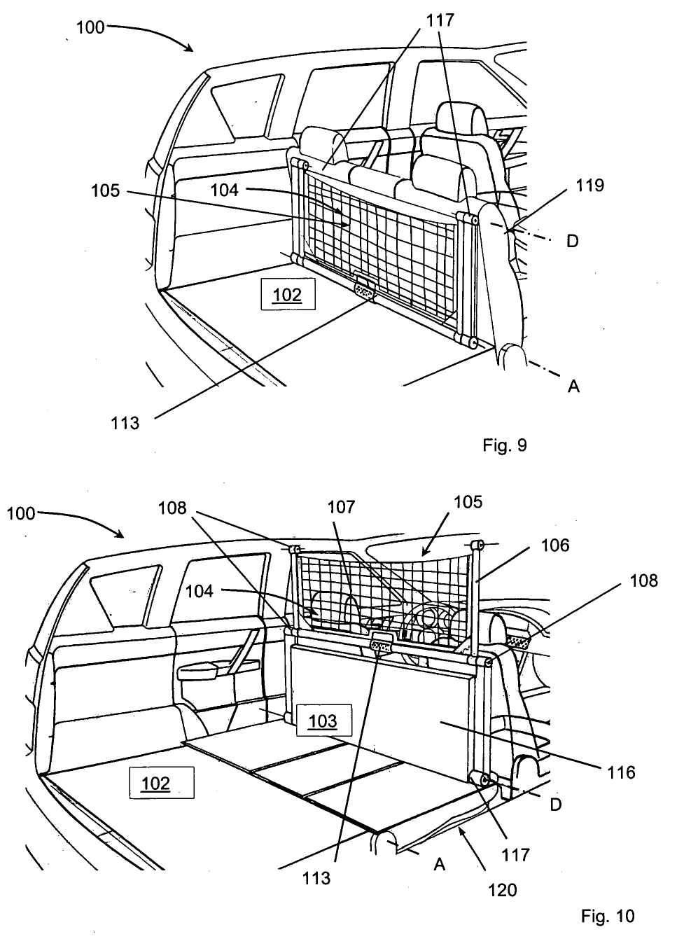

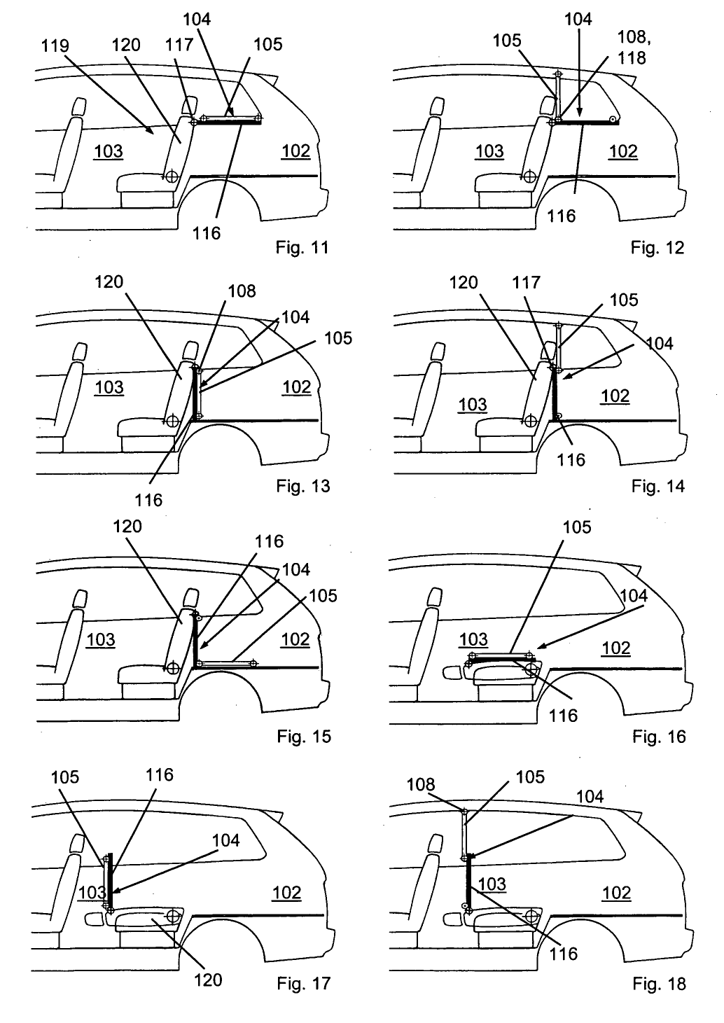

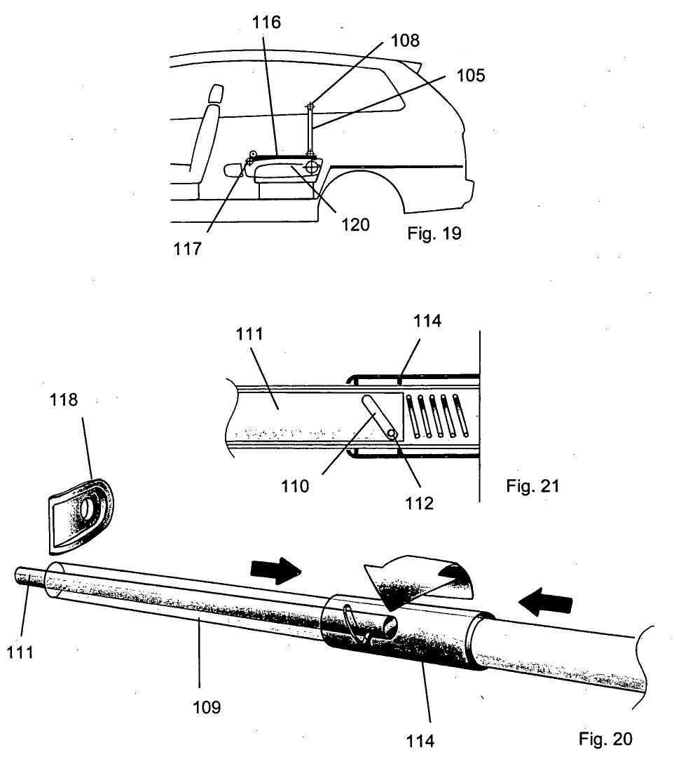

In a second embodiment of the present invention that is illustrated in FIGS. 5 and 6, the cargo space 11 contains a cargo floor 41 that forms a stationary part of the floor lining. A movable part of the floor lining 42 is preferably accommodated in a displaceable fashion in a pocket or recess of the stationary floor lining 41. The movable part of the floor lining 42 preferably can be displaced linearly forward in the direction of the area 12. A cargo space partition 3 is arranged on the movable part of the floor lining 42, namely in the front region thereof. This cargo space partition comprises a first plate-shaped element 31 that essentially extends vertically upward from the plane of the convertible floor lining 42, namely as far as the region of the upper edge of the back rest 22 of the rear seat or the rear bench seat 2. A second plate-shaped element 32 is movably and/or detachably arranged on the first plate-shaped element 31. This second plate-shaped element contains an upper section that is designed for closing the opening remaining between the upper edge of the first plate-shaped element 31 and the roof lining of the motor vehicle. Another section on the second plate-shaped element 32 is designed for producing a connection with the first plate-shaped element 31. The second plate-shaped element 32 is preferably held in a displaceable fashion relative to the first plate-shaped element analogous to the above-described embodiment of the present invention. This holding arrangement may be realized, in particular, such that the second plate-shaped element 32 can be detached from the holding arrangement on demand. The second plate-shaped element 32 is preferably arranged in a displaceable fashion in a pocket in the first plate-shaped element 31 and can be accommodated therein in its entirety in a certain position.

The back rest 21 of the rear seat or the rear bench seat 2 is not folded over when only the cargo space 11 is used as shown in FIG. 5. The movable part of the floor lining 42 is then situated in a position, in which it does not protrude into the area 12. The second plate-shaped element 32 is arranged in its retracted or extracted position or in a position between the two end positions depending on the utilization of the cargo space 11.

If the area 11 [sic; 12] is also required for transporting cargo, the back rest 21 of the rear seat or the rear bench seat is folded forward as shown in FIG. 6. The movable part 42 of the floor lining protrudes relatively far forward over the converted back rest 21 in order to utilize the entire available cargo space. In this case, the second plate-shaped element 32 is usually displaced forward into its upper position in order to close any openings of the cargo area 11, 12 used.

Alternatively, the second plate-shaped element 32 may also be held in a pivoted fashion on the first plate-shaped element 31 in the above-described embodiment. A hinge with an essentially horizontal pivoting axis is preferably used for connecting an upper region of the first plate-shaped element 31 to an edge of the second plate-shaped element 32 or a section thereof that is situated adjacent to an edge. The hinge may be provided with a stopping mechanism that only allows a semicircular pivoting angle. The hinge preferably can be locked in both end positions.

The documents, patents and patent applications referred to herein are hereby incorporated by reference.

While the invention has been specifically described in connection with certain specific embodiments thereof, it is to be understood that this is by way of illustration and not of limitation, and the scope of the appended claims should be construed as broadly as the prior art will permit

1-16. (canceled)

17. A partition for a cargo space of a vehicle comprising a first plate-shaped elements and a second plate-shaped element, wherein one of the first and second plate-shaped elements is arranged on a seat of the vehicle such that said partition is capable of being pivoted about an axis, and wherein the first and second plate-shaped elements are connected to one another in a mutually displaceable fashion.

18. The partition according to claim 17, wherein the first and second plate-shaped elements are capable of being separated from one another.

19. The partition according to claim 17, wherein the first and second plate-shaped elements are capable of being interlocked with one another.

20. The partition according to claim 17, wherein the first and second plate-shaped elements are pivotally connected to one another.

21. The partition according to claim 17, wherein the first and second plate-shaped elements extend substantially parallel to one another.

22. The partition according to claim 17, wherein a position of the axis is fixed in relation to the first plate-shaped element.

23. The cargo space partition according to claim 17, wherein a position of the axis varies in relation to the first plate-shaped element.

24. The cargo space partition according to claim 17, wherein the first and second plate-shaped elements are connected to one another in the mutually displaceable fashion by means of a slip-in guide.

25. The cargo space partition according to claim 24, wherein the slip-in guide causes the first and second plate-shaped elements to carry out an essentially linear movement relative to one another.

26. The cargo space partition according to claim 17, wherein one of the first and second plate-shaped elements can be moved in a pocket of the other plate-shaped element.

27. A partition for a cargo space of a vehicle comprising a first plate-shaped element and a second plate-shaped element, wherein one of first and second plate-shaped elements is adapted to be displaced substantially perpendicular and linearly with respect to a cargo floor of the vehicle.

28. The partition according to claim 27, wherein the first plate-shaped element is mounted on a movable part of the cargo floor.

29. The partition according to claim 28, wherein the movable part of the cargo floor is adapted to be moved into a pocket or recess of the cargo floor.

30. The partition according to claim 27, wherein the second plate-shaped element is mounted on the first plate-shaped element in a displaceable fashion.

31. The partition according to claim 30, wherein the second plate-shaped element is slidably mounted in a pocket of the first plate-shaped element.

32. The partition according to claim 27, wherein the second plate-shaped element is pivotally mounted on the first plate-shaped element.

33. A cargo space partition for vehicle comprising a first separating element and a second separating element, the first separating element pivotable about a first hinged connection and including locking means slidably mounted proximate a first longitudinal edge, the second separating element pivotable about a second hinged connection and including a catch member for engaging the locking means, thereby allowing the first and second separating elements to be place in a plurality of different configurations.

34. The partition according to claim 33, wherein the first and second hinged connections define a rotational axis (B, C) that are substantially aligned and in parallel with each other.

35. The partition according to claim 33, wherein the first separating element includes a second longitudinal edge that is substantially aligned and in parallel with the first longitudinal edge.

36. The partition according to claim 33, wherein the first and second separating elements are essentially plate-like in shape.

37. The partition according to claim 33, further comprising a handle located adjacent to the first longitudinal edge of the first separating member for actuating the locking means in order to engage or disengage the first and second hinged connections.

38. The partition according to claim 37, wherein the handle includes a rotatably mounted handle sleeve being connected to the locking means for actuating the locking means.

39. The partition according to claim 38, wherein said locking means comprises a spring-biased locking bolt and angled slot having a rod disposed therein for allowing the locking bolt to be moved by rotation of the sleeve.

40. The partition according to claim 33, wherein said second separating element is provided with a hinge member laterally mounted thereto, said hinge member allowing to pivotably connect said second separating element to the vehicle.
